(19) United States
(12) Patent Application Publication
(10) Pub. No.: US 2012/0224037 A1
(43) Pub. Date: Sep. 6, 2012

(54) REDUCING VIEWING DISCOMFORT FOR GRAPHICAL ELEMENTS

(75) Inventors: Yeping SU, Cupertino, CA (US); Hao PAN, Camas, WA (US); Chang YUAN, Vancouver, WA (US)

(73) Assignee: SHARP LABORATORIES OF AMERICA, INC., Camas, WA (US)

(21) Appl. No.: 13/039,148

(22) Filed: Mar. 2, 2011

(51) Int. Cl. H04N 13/04

(52) U.S. Cl. 348/55; 348/E13.075

(57) ABSTRACT

A method for displaying a pair of stereoscopic images together with a graphical element on a display including receiving a pair of images forming the pair of stereoscopic images, one being a left image and one being a right image. Estimating a disparity between the left image and the right image based upon a matching of a left region of the left image with a right region of the right image. Also, estimating a disparity for a graphical element to be displayed together with the pair of images on the display based upon a disparity of a spatial region of the pair of images. Based upon the estimated disparity of the pair of images and the estimated disparity of the graphical element modifying at least one of the right image and the left image to be displayed upon the display.

### CROSS-REFERENCE TO RELATED APPLICATIONS

Not applicable.

### BACKGROUND OF THE INVENTION

The present invention relates generally to displaying stereoscopic images on a display.

Viewing stereoscopic content on planar stereoscopic display sometimes triggers unpleasant feelings of discomfort or fatigue in the viewer. The discomfort and fatigue may be, at least in part, caused by limitations of existing planar stereoscopic displays. A planar stereoscopic display, no matter whether LCD based or projection based, shows two images with disparity between them on the same planar surface. By temporal and/or spatial multiplexing the stereoscopic images, the display results in the left eye seeing one of the stereoscopic images and the right eye seeing the other one of the stereoscopic images. It is the disparity of the two images that results in viewers feeling that they are viewing three dimensional scenes with depth information. This viewing mechanism is different from how eyes normally perceive natural three dimensional scenes, and may cause a vergence-accommodation conflict. The vergence-accommodation conflict strains the eye muscle and sends confusing signals to the brain, and eventually causes discomfort/fatigue.

The preferred solution is to construct a volumetric three dimensional display to replace existing planar stereoscopic displays. Unfortunately, it is difficult to construct such a volumetric display, and is likewise difficult to control such a display.

Another solution, at least in part, is based upon signal processing. The signal processing manipulates the stereoscopic image pair sent to the planar stereoscopic display in some manner. Although the signal processing cannot fundamentally completely solve the problem, the vergence-accommodation conflict can be significantly reduced and thereby reduce the likelihood of discomfort and/or fatigue.

What is desired is a display system that reduces the discomfort and/or fatigue for stereoscopic images.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a stereoscopic viewing system for reducing discomfort and/or fatigue.

FIG. 2 illustrates disparity estimation with a graphical element.

FIG. 3 illustrates a local disparity analysis.

FIG. 4 illustrates another local disparity analysis.

### DETAILED DESCRIPTION OF PREFERRED EMBODIMENT

The system provides a signal processing based technique to reduce the discomfort/fatigue associated with a three dimensional viewing experience. More specifically, given a planar stereoscopic display, the technique takes in a stereoscopic image pair that may cause viewing discomfort/fatigue, and outputs a modified stereoscopic pair that causes less or no viewing discomfort/fatigue.

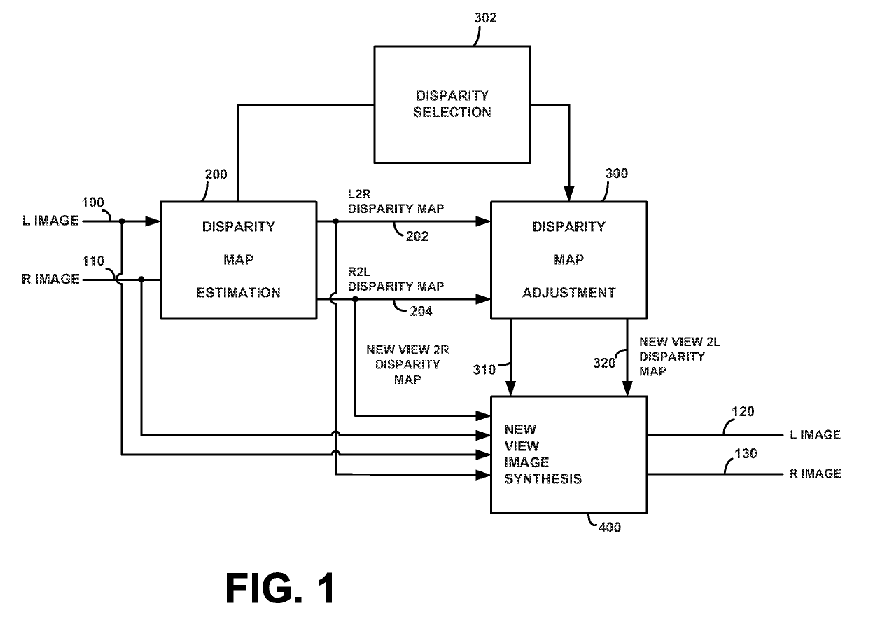

One simplified example (merely for purposes of illustration) of a stereoscopic processing system for reducing viewer discomfort is illustrated in FIG. 1. This technique receives a stereoscopic pair of images 100, 110, in which one image 100 is for the left eye to view (L image) and the other image is for the right eye to view (R image) 110, and outputs a modified stereoscopic pair of images 120 (L image), 130 (R image) where one or both of the input images may be modified in some manner. If the input stereoscopic image pairs have very large disparities in some areas between two images, the large disparities may cause severe vergence-accommodation conflict that leads to discomfort or even fatigue for some viewers.

As shown in FIG. 1, the technique may include some principal components, namely, a disparity map estimation 200, a disparity map adjustment 300, and a new view image synthesis 400. For simplicity, the system may presume that the input stereoscopic pair has been rectified so the disparity between two images is only horizontal. In other cases, the system may modify accordingly where the input stereoscopic pair is rectified in any other direction or otherwise not rectified.

The disparity map estimation 200 outputs two disparity maps, L2R map 202 and R2L map 204. The L2R map 202 gives the disparity of each pixel in the L image, while the R2L map 204 gives the disparity of each pixel in the R image. The data also tends to indicate occlusion regions which may be accounted for in the new view image synthesis 400. The disparity map estimation 200 also provides matching errors of the two disparity maps, which provides a measure of confidence in the map data.

The adjustment based on the L2R map 202 and the R2L map 204 in the disparity map adjustment 300 may be controlled by a disparity selection 302. The disparity selection 302 may predict the discomfort based upon the estimated disparity in the image pairs 202, 204, viewing conditions, display characteristics, viewer preferences, and/or any other suitable data. Based upon this estimation, the amount of disparity may be modified. The modification may result in global modification, object based modification, region based modification, or otherwise. A modified set of disparity maps 310, 320 are created by the disparity map adjustment 300. The modified disparity maps may include the newview2R disparity map 310 and the newview2L disparity map 320 which are provided to the new view image synthesis 400.

The new view image synthesis 400 synthesizes the new views 120 and/or 130 based upon data from the disparity map adjustment 300, the disparity map estimation 200, and the input image pair 100, 110. It is to be understood that any suitable technique may be used to compute disparities or otherwise the disparities may be provided together with the video content, and one or more new images may be computed as a result.

While this technique of computing the disparity information is suitable for image content from a content provider from which disparity information is traditionally provided or computed, there are other types of content such as graphical elements that are rendered on the display that do not contain disparity information from the content provider. Some of the types of graphical elements includes captions, menus, and logos. Often, these graphical elements are inserted into the video stream or otherwise indicated to be displayed on the display, after the video content is obtained. For example, while obtaining three dimensional video content of a live football game, graphical overlays may be provided with scoring or other information that should also be displayed on the display. When graphical overlays are rendered on a traditional two-dimensional display, the horizontal and vertical positions for the graphical element are provided. When a graphical element is rendered on a stereoscopic display, the disparity information for the graphical element should be provided. That is to say that the graphical elements should be rendered on both the left view and the right view with the appropriate amount of horizontal displacement.

One approach for rendering the graphical elements is to use a fixed disparity value, such as for example zero disparity or a pre-determined negative disparity. Unfortunately, using a fixed disparity tends to result in a visual conflict at the boundaries where the graphical element and the three dimensional video content being display have substantially different disparities. This conflict of different disparities tends to make it hard to fuse both views together and ultimately tends to result in discomfort for the viewers.

A modified technique for the suitable presentation of a graphical element on a stereoscopic display should be based upon the local disparity in the region where the graphical element is to be displayed. In this manner, the local content of the region where the graphical element is to be displayed is used to determine the disparity to be used for the graphical element, and therefore the disparity of the local region and the graphical element will substantially match one another. The result of such a content-dependent technique for determining the disparity information is that fewer artifacts are created and a more comfortable viewing experience is achieved for the viewer.

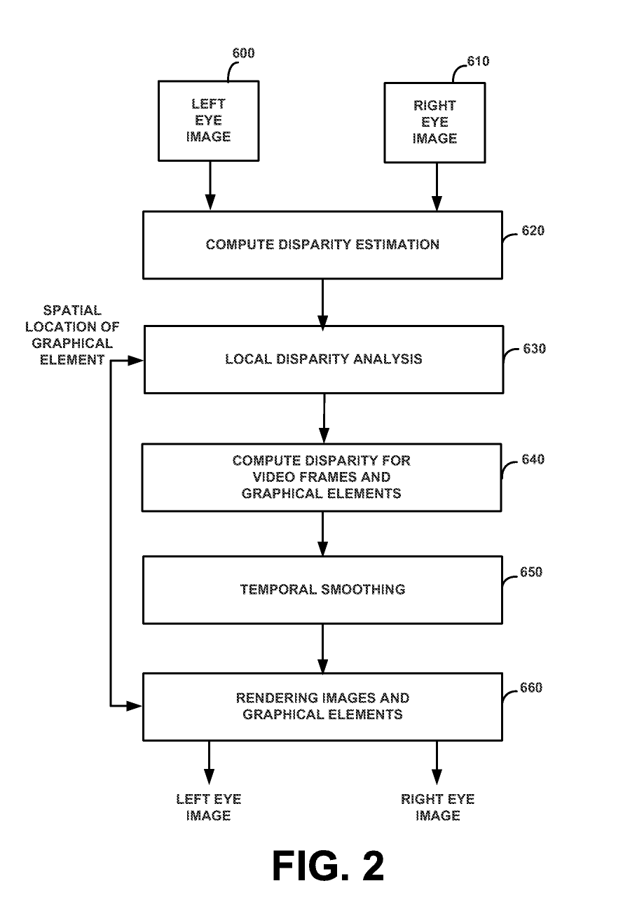

Referring to FIG. 2, one implementation of such a system is illustrated. The left-eye image 600 and the right eye image 610 are received by the system. The system computes a disparity estimation 620, which may for example be computed as described in FIG. 1 or any other suitable technique. The result of the disparity estimation 620 may be any suitable data that provides information regarding the disparity between the images at different positions within the images. In addition, the disparity information may be provided together with the images.

A local disparity analysis 630 may compute a disparity histogram of a local window where the geographical element is to be located. This aggregates disparity data that may be used for determining a suitable disparity for the graphical element.

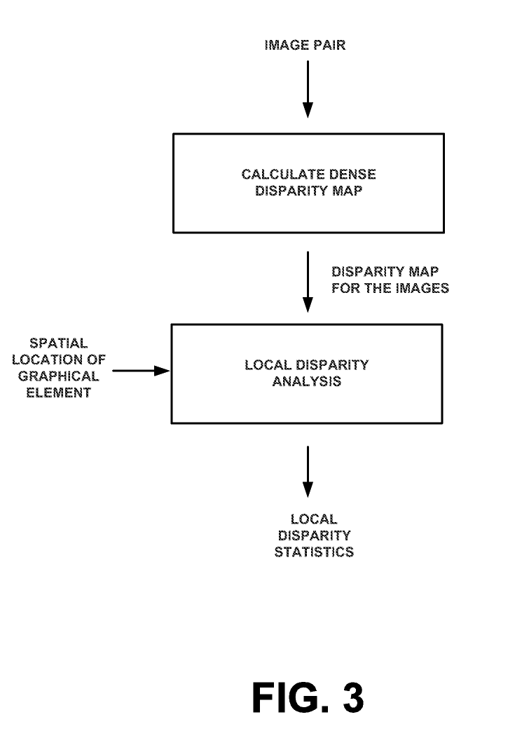

Referring also to FIG. 3, the local disparity estimation 630 may estimate a dense disparity map between the entire left image and the entire right image. The dense disparity map contains disparities for each pixel in either the left image and/or the right image, with the former being referred to as L2R map and the later being referred to as R2L map. With the intended spatial location and/or the size of the graphical overlay being known, a rectangular bounding box/window (or any other defined region or space) may be defined that generally covers the area where the graphical element is to be located. A horizontal disparity histogram may be collected from the disparity values associated with the pixels in the window. A histogram cleaning step may be applied, that removes outliers with extreme disparities. For example, disparities within the range of 5% and 95% percentiles in the histogram may be retained. The local disparity analysis results in local disparity statistics which are then used to determine a suitable disparity for the graphical element.

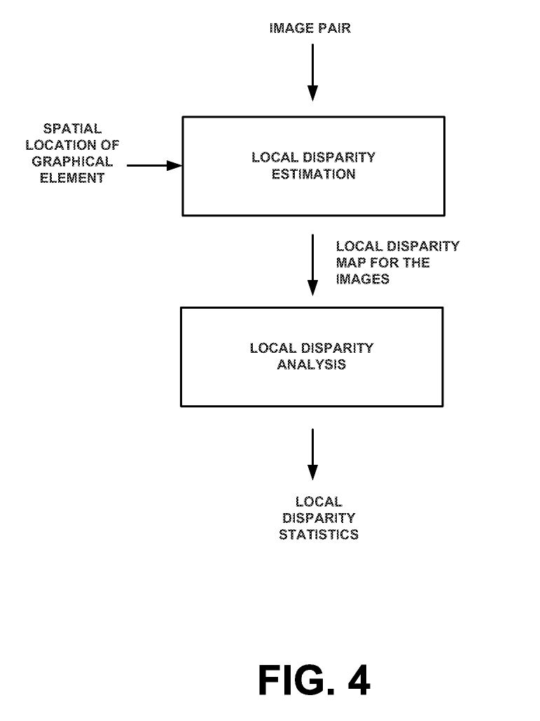

Referring also to FIG. 4, the local disparity estimation 630 may alternatively substantially compute the disparities within the intended window for the graphical element. In this case, the disparity estimation produces a local disparity histogram which reduces the computational complexity of the system.

The preferred disparity for the video content of the current frames together with one or more graphical elements 640 may be computed. In this manner, the disparities for the video images are determined and those regions of the image that correspond to graphical elements are likewise determined, both in a manner suitable to reduce viewer discomfort.

The disparity for the local window may be computed in any suitable manner, such as by using a histogram. For example, the disparity associated with the graphical element may be a mean disparity, a most frequent disparity, or a minimal disparity. The mean disparity may be determined as the mean disparity of substantially all the samples in the histogram. The most frequent disparity may be determined as the disparity value associated with the highest count in the histogram. The minimal disparity may be determined as the minimal disparity in the histogram. The minimal disparity in the histogram tends to ensure that the graphical element will be placed “on top of” the underlying content in terms of perceived depth, which is usually what a viewer would expect to observe for a graphical element.

In some cases, the local disparity will vary significantly between temporal frames, especially in the case of a shot boundary in the video. Accordingly, a temporal smoothing 660 of the disparity calculations 650 is preferably used to smooth out such effects. For example, assuming the disparity of the graphical element is determined to be d(t), the system may apply a temporal filter to reduce the disparity from changing to dramatically from frame to frame. As one particular embodiment, an infinite impulse response filter may be used: \hat{d}(t)=α•\hat{d}(t−1)+(1−α)•d(t). If a shot boundary is detected, the temporal smoothing may be turned off (or substantially reduced) to avoid false disparity information being leaked from one shot to the next shot, as defined by:

$$\hat{d} ( t ) = \{ \frac{α \cdot \hat{d} ( t - 1 ) + ( 1 - α ) \cdot d ( t )}{d ( t )} \} \begin{matrix}no\_shot \_boundary \_at \_t \\ shot\_boundary \_at \_t .\end{matrix}$$

With the disparities for graphical elements being content-dependent on the particular region(s) of the display, together with temporal smoothing, the disparity estimates for rendering the images are determined 660 and the graphical elements are rendered on both the left image and the right image with the appropriate disparity values. For example, the final disparities estimate \hat{d}(t) for the on-screen graphical element(s) may be rendered and positioned. Assuming the intended spatial location of the left image is [Gₓ(t), G_{y}(t)], the same overlay may be placed on the right image as [Gₓ(t)+\hat{d}(t), G_{y}(t)]. The opacity of the graphical overlay may also be modified based on its disparity. For example, if there is a strong conflict between the scene disparities and the graphical disparities, the opacity of the graphical element may be reduced which reduces the visual discomfort.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for displaying a pair of stereoscopic images together with a graphical element on a display comprising:
(a) receiving a pair of images forming said pair of stereoscopic images, one being a left image and one being a right image;
(b) estimating a disparity between said left image and said right image based upon a matching of a left region of said left image with a right region of said right image;
(c) estimating a disparity for a graphical element to be displayed together with said pair of images on said display based upon a disparity of a spatial region of said pair of images;
(d) based upon said estimated disparity of said pair of images and said estimated disparity of said graphical element modifying at least one of said right image and said left image to be displayed upon said display.

2. The method of claim 1 wherein said stereoscopic images include a horizontal disparity.

3. The method of claim 1 wherein said disparity estimation provides a LtoR disparity map, a RtoL disparity map, a RtoL disparity matching errors, and LtoR disparity matching errors.

4. The method of claim 3 wherein said adjusted disparity is further based upon a viewer preference.

5. The method of claim 4 wherein said adjusted disparity is further based upon a model based upon display characteristics of said display.

6. The method of claim 1 wherein said estimating said disparity of said graphical element is performed after said estimating said disparity between said left image and said right image.

7. The method of claim 1 wherein said estimating said disparity of said graphical element is performed before said estimating said disparity between said left image and said right image.

8. The method of claim 1 wherein said graphical element is received without disparity information.

9. The method of claim 1 wherein a location to position said graphical element within said image is received.

10. The method of claim 9 wherein said disparity of said graphical element is not a fixed disparity value.

11. The method of claim 10 wherein said disparity of said graphical element is based upon the disparity proximate said location.

12. The method of claim 11 wherein said disparity of said graphical element is substantially the same as the disparity of said pair of images proximate said location.

13. The method of claim 12 wherein said disparity of said graphical element is substantially the same as the disparity of said pair of images proximate the boundaries of said graphical element.

14. The method of 11 wherein said disparity of said graphical element is further based upon a temporal characterization.

15. The method of claim 11 wherein said disparity of said graphical element is based upon a histogram.

16. The method of claim 15 wherein said disparity of said graphical element is further based upon a minimal disparity.

17. A method for displaying a pair of stereoscopic images together with a graphical element on a display comprising:
(a) receiving a pair of images forming said pair of stereoscopic images, one being a left image and one being a right image together with a disparity between said left image and said right image;
(b) estimating a disparity for a graphical element to be displayed together with said pair of images on said display based upon a disparity of a spatial region of said pair of images;
(c) based upon said disparity of said pair of images and said estimated disparity of said graphical element modifying at least one of said right image and said left image to be displayed upon said display.
